(19) United States
(12) Patent Application Publication
(10) Pub. No.: US 2026/0161883 A1
(43) Pub. Date: Jun. 11, 2026

(54) INLINE PRESENTATION OF STYLED, CONTEXT-AWARE TEXT SUGGESTIONS

(71) Applicant: Superhuman Platform Inc., San Francisco, CA (US)

(72) Inventors: Yura Tanskyi, San Francisco, CA (US); Steven Harbaruk, Vancouver (CA); Andrew Stromme, San Francisco, CA (US); Victor Pavlychko, San Francisco, CA (US); Ivan German, San Francisco, CA (US); Prasad Shirvandkar, Santa Clara, CA (US)

(21) Appl. No.: 19/413,402

(22) Filed: Dec. 9, 2025

Related U.S. Application Data
(60) Provisional application No. 63/729,816, filed on Dec. 9, 2024.

(51) Int. Cl. G06F 40/166; G06F 40/117; G06F 40/14; G06F 40/40

(52) U.S. Cl. CPC G06F 40/166; G06F 40/117; G06F 40/14; G06F 40/40

(57) ABSTRACT

A source text and context data related to the source text are captured from a focused window on a first computer system. A graphical user interface (GUI) is displayed on the first computer system concurrently with the focused window, indicating a set of actions that can be performed in relation to the source text and a chat input field for use in prompting a large language model (LLM). A user of the first computer system can provide user input to select an action from the set of actions indicated in the graphical user interface or to input free-form text into the chat input field for use in prompting the LLM. A message is received from a second computer system, indicative of a suggested improvement to the source text. Text in the focused window is decorated with markup to indicate the suggested improvement, in response to the third message.

This application claims the benefit of U.S. provisional patent application no. 63/729,816, filed on Dec. 9, 2024, which is incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2024, 2025, SUPERHUMAN PLATFORM INC.

### TECHNICAL FIELD

One technical field of the present disclosure is computer-implemented natural language processing. Another technical field is natural language text addition, modification, or suggestion.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by their inclusion in this section.

Computer-implemented writing assistants may provide suggestions and feedback across various software platforms and applications. Different styles of writing may be appropriate or desirable depending on the context of the writing. Users may also prefer writing suggestions and feedback to be generated in a style that matches the user's writing. Computer-implemented generative artificial intelligence (AI) systems, including generative AI software and systems capable of automatically generating text content in response to a prompt based on trained machine learning models like large language models (LLMs), can be used to produce text written in a variety of different styles. However, generative AI systems may only be accessible through chatbot windows and may not be accessible across the variety of software platforms and applications in which writing support is sought.

Based on the foregoing, the referenced technical fields have developed an acute need for a writing assistant that can provide styled, context-aware suggestions and feedback for writing across a range of platforms and applications.

### SUMMARY

In some embodiments of the technique introduce here, a source text and context data related to the source text are captured from a focused window on a first computer system. A graphical user interface (GUI) is displayed on the first computer system concurrently with the focused window, indicating a set of actions that can be performed in relation to the source text and a chat input field for use in prompting a large language model (LLM). A user of the first computer system can provide user input to select an action from the set of actions indicated in the graphical user interface or to input free-form text into the chat input field for use in prompting the LLM. A message is received from a second computer system, indicative of a suggested improvement to the source text. Text in the focused window is decorated with markup to indicate the suggested improvement, in response to the third message.

In some embodiments, the technique introduced here includes a method of enabling provision of writing assistance to a user of a first computer system. The method may include receiving a first request from the first computer system, and sending, to the first computer system and in response to the first request, computer program code that, when executed by the first computer system, causes the first computer system to perform operations including: capturing, from a focused window displayed by at least one display device of the first computer system, a source text and context data related to the source text, based on a relevance criterion; sending a first message including the source text from the first computer system to a second computer system; causing a graphical user interface to be displayed on at least one display device of the first computer system concurrently with a displaying of the focused window, where the graphical user interface is distinct from the focused window and indicates a set of actions that can be performed in relation to the source text and a chat input field for use in prompting a large language model (LLM), the graphical user interface enabling an user of the first computer system to select an action from the set of actions indicated in the graphical user interface or to input free-form text into the chat input field for use in prompting the LLM; receiving first user input directed to the graphical user interface, the first user input selecting an action from the set of actions or specifying free-form text in the chat input field; sending, to the second computer system, a second message indicative of the first user input; receiving, from the second computer system, a third message responsive to the second message, the third message being indicative of a suggested improvement to the source text; and causing at least a portion of text in the focused window to be decorated with markup in the focused window to indicate the suggested improvement, in response to the third message. Other embodiments of this aspect include corresponding computer systems, apparatus, and computer programs recorded on one or more computer storage devices, each configured to perform the actions of the methods.

Implementations may include one or more of the following features. The method where in response to the first user input having free-form text input into the chat input field, the third message includes at least a portion of a response by the LLM to a prompt that was based on the first user input. The method further may include: applying, by the first computer system, a transformation to the suggested improvement based on a writing quality criterion, to produce a transformed suggested improvement; where the causing at least a portion of text in the focused window to be decorated in the focused window is based on the transformed suggested improvement. The method where the source text may include text located in an active field of the focused window and the context data may include text outside the active field of the focused window. The method where the source text may include selected text in the focused window and the context data may include unselected text in the focused window. The method where the capturing filters out control elements from the focused window. The method of where the capturing may include traversing a hierarchical metadata structure representative of the focused window to extract relevant content. The method where the hierarchical metadata structure is an accessibility tree. The method of where the hierarchical metadata structure is a document object model (DOM). The method where the capturing where the capturing may include: accessing the hierarchical metadata structure; selecting first data elements of the hierarchical metadata structure corresponding to specified attributes; and pruning second data elements from the hierarchical metadata structure based on a specified relevance criterion. The method where the hierarchical metadata structure is in a JSON format, and where the capturing further may include converting at least a portion of the hierarchical metadata structure from the JSON format to whitespace-indented text. The method where the source text may include an entire email thread, and where one of the actions, of the set of actions, is to summarize the entire email thread. Implementations of the described techniques may include hardware, a method or process, or a computer tangible medium.

In some embodiments, the technique introduced here may include a method of providing writing assistance to an user of a first computer system, where the method may include receiving, by a second computer system, a source text and context data related to the source text, the source text being at least a portion of text in a focused window displayed by the first computer system. The method may also include receiving, by the second computer system, an indication of a first user input applied at the first computer system, the first user input indicating including free-form text input by the user of the first computer system. The method may also include generating, by the second computer system, a prompt for a large language model (LLM), based on at least a portion of the source text and the free-form text input by the user at the first computer system. The method may also include providing, by the second computer system, the prompt to the LLM by invoking an application programming interface of the LLM. The method may also include receiving, by the second computer system, a response to the prompt from the LLM, the response to the prompt from the LLM including a suggested improvement to the source text. The method may also include sending, by the second computer system, a message indicative of the suggested improvement to the first computer system, based on the response to the prompt from the LLM, to cause the first computer system to display at least a portion of the response to the prompt from the LLM. Other embodiments of this aspect include corresponding computer systems, apparatus, and computer programs recorded on one or more computer storage devices, each configured to perform the actions of the methods.

Implementations may include one or more of the following features. The method further may include: applying, by the second computer system, a transformation to the suggested improvement to the source text based on a writing quality criterion, to produce a transformed suggested improvement, where the message indicative of the suggested improvement contains the transformed suggested improvement. The method further may include: receiving or generating, by the second computer system, a subset of a hierarchical metadata structure representative of content of the focused window, where the generating the prompt is based on the subset of the hierarchical metadata structure and the free-form text input by the user at the first computer system. The method where the hierarchical metadata structure is an accessibility tree. The method where the hierarchical metadata structure is a document object model (DOM). The method where the hierarchical metadata structure is in a JSON format, and where the subset of the hierarchical metadata structure is in a whitespace-indented text format. The method where generating the prompt generating a plurality of user messages, including generating a separate user message to include each of where generating the prompt may include generating a plurality of user messages, including generating a separate user message to include each of: an user-selected portion of text from the focused window, if any text in the focused window has been selected by the user of the first computer system; a processed hierarchical metadata structure representative of the focused window; and an user-input request or question input by the user of the first computer system. The method where the source text and the context data collectively may include an entire email thread. Implementations of the described techniques may include hardware, a method or process, or a computer tangible medium.

In some embodiments, the system introduced here may include a system for providing context-aware text suggestions in conjunction with text entered in an application window. The system may include at least one processor and at least one memory, accessible to the processor and storing program code that includes or implements: a text processing extension configured to execute on a client computing device and configured to monitor a focused application window to capture a body of text and context data. The code may further include a prompt engineering module configured to execute on a server and configured to: upon receipt of the body of text and context data, select one or more writing actions from a predefined set of candidate actions based on the captured context data; generate one or more engineered prompts for a large language model by applying prompt logic to the writing actions, the context data, and an user-specified or default writing style. The code may further include a language model interface module configured to transmit the one or more engineered prompts to a large language model and to receive one or more generated text responses. The code may further include a response unifier module configured to unify the one or more generated text responses into a unified suggestion set. The code may further include a presentation module configured to execute on the client computing device and configured to: receive the unified suggestion set; and present at least one suggested text to an user either as inline decorations in the focused application window, where additions are highlighted and deletions are struck through relative to the captured body of text. Other embodiments of this aspect include corresponding computer systems, apparatus, and computer programs recorded on one or more computer storage devices, each configured to perform the actions of the methods.

A system of one or more computers can be configured to perform particular operations or actions such as mentioned above and as further described below, by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

### BRIEF DESCRIPTION OF THE DRAWINGS

In the drawings:

FIG. 1 illustrates a distributed computer system showing the context of use and principal functional elements with which one embodiment could be implemented.

FIG. 2 illustrates a computer system with which one embodiment could be implemented.

FIG. 3 illustrates an example of a computer-implemented or programmed process for displaying a ranked list of actions.

FIG. 4 illustrates an example of computer-implemented or programmed process for generating a suggestion set.

FIG. 5 illustrates a computer-implemented or programmed process for displaying a suggestion in a chat panel or as an inline decoration.

FIG. 6 illustrates a computer-implemented or programmed process for generating a replacement suggestion in a selected writing style.

FIG. 7 illustrates an example of a graphical user interface that may be programmed to display a ranked list of actions in conjunction with an application.

FIG. 8A illustrates an example of a graphical user interface that may be programmed to display an action in conjunction with an application.

FIG. 8B illustrates an example of a graphical user interface that may be programmed to display multiple alternative approaches with labeled tabs in conjunction with an application.

FIG. 9 illustrates an example of a graphical user interface that may be programmed to display a list of writing styles in conjunction with an application.

FIG. 10A illustrates an example of a graphical user interface that may be programmed to display an input field for a custom writing style in conjunction with an application.

FIG. 10B illustrates an example of a graphical user interface that may be programmed to display an analysis of a custom writing style in conjunction with an application.

FIG. 11 illustrates an example of a graphical user interface that may be programmed to display a suggestion in an inline decoration in conjunction with an application.

FIG. 12 is a flowchart of an example process according to the technique introduced above.

FIG. 13 is a flowchart of another example process according to the technique introduced above.

### DETAILED DESCRIPTION

### 1. General Overview

In the following description, to illustrate clear examples, numerous specific details are outlined to provide a thorough understanding of the present invention. It will be apparent, however, that the present invention may be practiced without these specific details. In other instances, well known structures and devices are shown in block diagram form to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail outlined in this disclosure is the same level of detail that persons of skill in the art normally use to communicate with one another to express algorithms to be programmed or the structure and function of programs to implement the inventions claimed herein.

One or more different inventions may be described in this disclosure, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described concerning one or more particular embodiments or drawing figures, but such features are not limited to usage in the one or more particular embodiments or figures concerning which they are described. Thus, the present disclosure is neither a literal description of all embodiments of one or more of the inventions nor a listing of features of one or more of the inventions that must be present in all embodiments.

Headings of sections and the title are provided for convenience but are not intended to limit the disclosure in any way or as a basis for interpreting the claims. Devices that are described as in communication with each other need not be in continuous communication with each other unless expressly specified otherwise. In addition, devices that communicate with each other may communicate directly or indirectly through one or more intermediaries, logical or physical.

A description of an embodiment with several components in communication with one other does not imply that all such components are required. Optional components may be described to illustrate a variety of possible embodiments and to fully illustrate one or more aspects of the inventions. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in some embodiments or some occurrences, or some steps may be executed more than once in a given embodiment or occurrence. When a single device or article is described, more than one device or article may be used in place of a single device or article. Where more than one device or article is described, a single device or article may be used in place of more than one device or article.

The functionality or features of a device may be alternatively embodied by one or more other devices that are not explicitly described as having such functionality or features. Thus, other embodiments of one or more of the inventions need not include the device itself Techniques and mechanisms described or referenced herein will sometimes be described in singular form for clarity. However, it should be noted that particular embodiments include multiple iterations of a technique or multiple manifestations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

### 2. Structural & Functional Overview

In one embodiment, a computer-implemented method is programmed to provide writing assistance in a style based on detected content from a focused application window. A default style may be automatically selected, or a user may select or define a different style. The computer-implemented method may generate several alternative suggestions based on the detected content from the focused application window. Example applications include email, instant messaging, collaborative online document editing systems, word processing applications, spreadsheets, and other personal or enterprise productivity applications.

### 2.1 Distributed Computer System Example

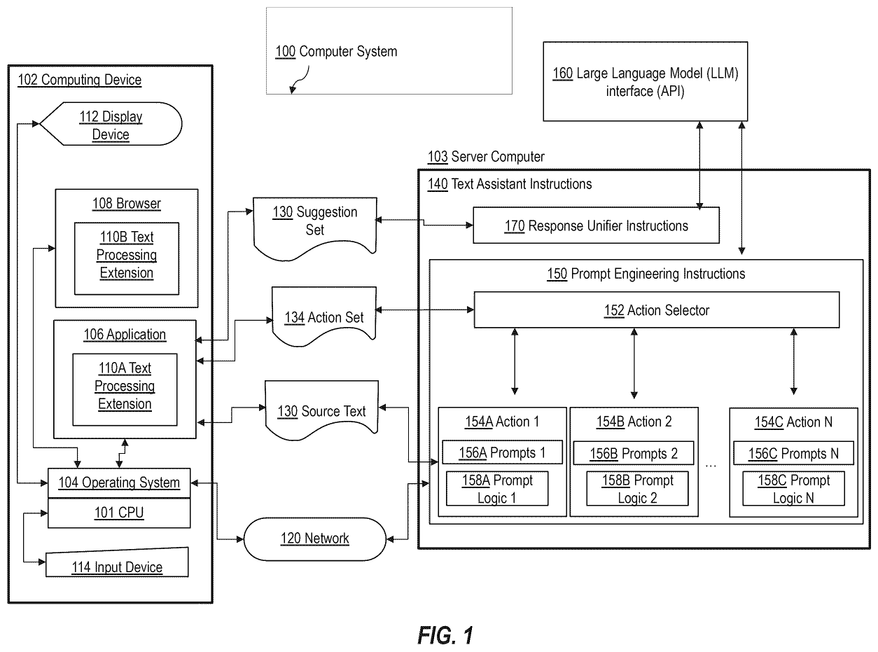

FIG. 1 illustrates a distributed computer system showing the context of use and principal functional elements with which one embodiment could be implemented. In an embodiment, a computer system 100 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of automatically domain-specific knowledge, definitions, links to people, or links to resources relevant to a text to a computing device in association with a writing or text preparation application. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

In the example of FIG. 1, computing device 102 is communicatively coupled via a network 120 to text assistant instructions 140. As used herein, the term “text” can include alphabetic characters, numbers, special characters, or a combination thereof. In one embodiment, computing device 102 comprises a personal computer, laptop, tablet, smartphone, or notebook computer configured as a client of the text assistant instructions 140. For purposes of illustrating a clear example, a single computing device 102, network 120, and text assistant instructions 140 are shown in FIG. 1, but practical embodiments may include thousands to millions of computing devices 102 distributed over a wide geographic area or over the globe, and hundreds to thousands of instances of text assistant instructions 140 to serve requests and computing requirements of the computing devices.

Computing device 102 comprises, in one embodiment, a central processing unit (CPU) 101 coupled via a bus to a display device 112 and an input device 114. In some embodiments display device 112 and input device 114 are integrated, for example, using a touch-sensitive screen to implement a soft keyboard. CPU 101 hosts operating system 104, which may include a kernel, primitive services, a networking stack, and similar foundation elements implemented in software, firmware, or a combination. Operating system 104 supervises and manages one or more other programs. For purposes of illustrating a clear example, FIG. 1 shows the operating system 104 coupled to an application 106 and a browser 108, but other embodiments may have more or fewer apps or applications hosted on a computing device 102.

At runtime, one or more of application 106 and browser 108 loads or are installed with text processing extensions 110A and 110B, which comprise executable instructions that are compatible with text assistant instructions 140 and may implement application-specific communication protocols to rapidly communicate text-related commands and data between the extension and the text processor. Text processing extensions 110A and 110B may be downloaded to computing device 102 from the server computer 103 or a different computer in response to, for example, a user-initiated a request from computing device 102. Text processing extensions 110A and 110B may be implemented as runtime libraries, browser plug-ins, browser extensions, or other means of adding external functionality to otherwise unrelated, third-party applications or software. The precise means of implementing text processing extensions 110A, 110B or obtaining input text is not critical, provided that an extension is compatible with and can be functionally integrated with a host application 106 or browser 108.

In some embodiments, a text processing extension 110A may be installed as a stand-alone application that communicates programmatically with either or both of the operating system 104 and with an application 106. For example, in one implementation, text processing extension 110A executes independently of application 106 and programmatically calls services or APIs of operating system 104 to obtain the text that has been entered in or is being entered in input fields that the application manages. Accessibility services or accessibility APIs of the operating system 104 may be called for this purpose; for example, an embodiment can call an accessibility API that normally obtains input text from the application 106 and outputs speech to audibly speak the text to a user's computing device.

In some embodiments, each text processing extension 110A, 110B is linked, loaded with, or otherwise programmatically coupled to or with one or more of application 106 and browser 108 and, in this configuration, is capable of calling API calls, internal methods or functions, or other programmatic facilities of the application or browser. These calls or other invocations of methods or functions enable each text processing extension 110A, 110B to detect text that is entered in input fields, windows, or panels of application 106 or browser 108, instruct the application or browser to delete a character, word, sentence, or another unit of text, and instruct the application or browser to insert a character, word, sentence, or another unit of text.

Each text processing extension 110A, 110B is programmed to interoperate with a host application 106 or browser 108 to detect text in the application or browser, to transmit the text over network 120 to text assistant instructions 140 for server-side processing, to receive responsive data and commands from the text assistant instructions 140, and to execute presentation functions in cooperation with the host application or browser.

As one functional example, assume that browser 108 renders an HTML document that includes a body of text or a text entry panel in which a computing device can provide free-form text describing a product or service. The text processing extension 110B is programmed to detect the body of text via input from or using the computing device 102 and to transmit the body of text to text assistant instructions 140. In an embodiment, each text processing extension 110A, 110B is programmed to buffer or accumulate information relating to a body of text locally over a programmable period, for example, five seconds, and to transmit the accumulated information over that period as a batch to text assistant instructions 140. While not required, buffering or accumulation in this manner may improve performance by reducing network messaging roundtrips and reducing the likelihood that text information could be lost due to packet drops in the networking infrastructure.

A commercial example of text processing extensions 110A and 110B is the GRAMMARLY extension, commercially available from SUPERHUMAN PLATFORM INC.

Network 120 broadly represents one or more local area networks, wide area networks, campus networks, or internetworks in any combination, using any form of links from among terrestrial or satellite, wired, or wireless network links.

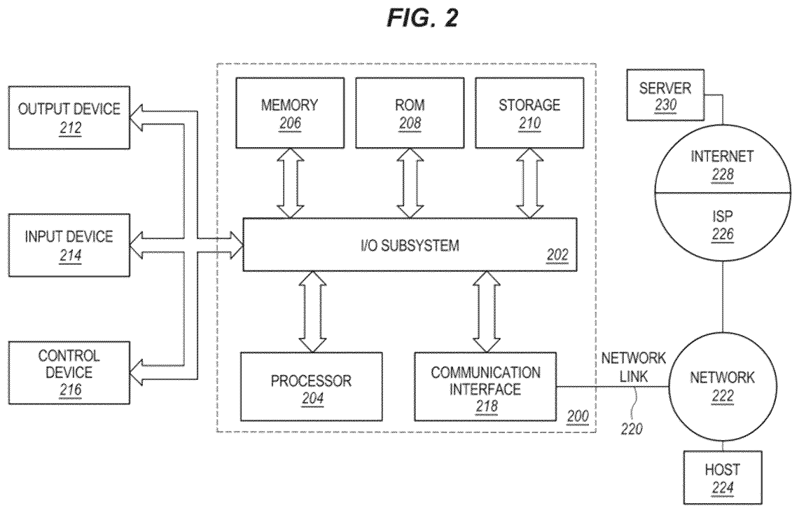

In an embodiment, the text assistant instructions 140 may be executed on server computer 103 or more than one server computer 103. In an embodiment, the assistant instructions 140 may also be executed on one or more workstations, computing clusters, and/or virtual machine processor instances, with or without network-attached storage or directly attached storage, located in any of enterprise premises, private data center, public data center, and/or cloud computing center. Server computer 103 broadly represents a programmed server computer with processing throughput and storage capacity sufficient to communicate concurrently with thousands to millions of computing devices 102 associated with different users or accounts. For purposes of illustrating a clear example and focusing on innovations that are relevant to the appended claims, FIG. 1 omits basic hardware elements of server computer 103 and text assistant instructions 140, such as a CPU, bus, I/O devices, main memory, and the like, illustrating instead an example software architecture for functional elements that execute on the hardware elements. Embodiments of server computer 103 could be implemented using the computer system shown in FIG. 2 and described separately in other sections below. Text assistant instructions 140 and server computer 103 also may include foundational software elements not shown in FIG. 1, such as an operating system consisting of a kernel and primitive services, system services, a networking stack, an HTTP server, other presentation software, and other application software. Thus, text assistant instructions 140 may execute on a first computer, and text processing extensions 110A and 110B may execute on a second computer.

In an embodiment, text assistant instructions 140 compose prompt engineering instructions 150 that are coupled indirectly to network 120. Prompt engineering instructions 150 is programmed to receive the text that text processing extensions 110A and 110B transmit to text assistant instructions 140 and to select actions with action selector 152 based on a body of text. Actions may be selected from a set of actions. The set of actions may include one or more actions, including actions 154A, 154B and 154C. To illustrate a clear example, source text 130 of FIG. 1 represents one or more documents that computing device 102 is viewing or reading via extensions 110A, 110B, that text processing extension 110B transmits to prompt engineering instructions 150. In an embodiment, prompt engineering instructions 150 is programmed to select actions from a set of actions based on a document that is being read and/or source text 130 arriving from text processing extensions 110A, 110B. In various embodiments, source text 130 can be obtained from an e-mail application such as GMAIL, an instant messaging application like SLACK, a web page that the browser 108 has accessed and rendered, or other applications.

Thus, in one embodiment, the text assistant instructions 140 may be programmed to programmatically receive a digital electronic object comprising a source text 130, a message with the source text 130, an application protocol message with the source text 130, an HTTP POST request with the source text 130 as a payload or using other programmed mechanics. The source text 130 can comprise a plurality of words. In various embodiments, a first computer executes text assistant instructions 140, which is communicatively coupled to text processing extensions 110A, and 110B executed at a second computer and programmatically receives the digital electronic object comprising the source text 130 via a message initiated at the text processing module and transmitted to the text assistant instructions; and/or the text processing extensions 110A, 110B executes in association with an application program that is executing at the second computer, where the text processing extensions 110A, 110B are programmed to receive an input signal, in response, to initiate the message; and/or the text assistant instructions executes in association with a browser executing at the second computer, with the text processing extensions 110A, 110B being programmed to receive an input signal and, in response, to initiate the message.

Each of the actions 154A, 154B, and 154C corresponds to a writing task that may be performed based on the source text 130. For example, actions 154A, 154B, and 154C may include reply, summarize, and improve. Actions 154A, 154B, and 154C may each include corresponding Prompt Engineering Platform (PEP) prompts 156A, 156B and 156C and prompt logic 158A, 158B, and 158C indicating additional information to add to prompts 156A, 156B and 156C.

Prompt engineering instructions 150 may use source text 130, action selector 152 actions 154A, 154B, and 154C, prompts 156A, 156B and 156C, and prompt logic 158A, 158B, and 158C to generate engineered prompts. Text assistant instructions 140 and prompt engineering instructions 150 may be communicatively coupled to an application programming interface (API) of a large language model (LLM) 160. For example, the text assistant instructions 140 is programmed to generate a request directed to an endpoint of an LLM such as CHATGPT, GEMINI, CLAUDE, etc. The request may include an engineered prompt and a user account identifier.

Text assistant instructions 140 may include response unifier instructions. Text assistant instructions may receive LLM responses to engineered prompts. Text assistant instructions 140 may submit multiple LLM API calls for a selected action in an embodiment. Text assistant instructions 140 may receive multiple LLM responses to the multiple LLM API calls and may unify the multiple LLM responses into a single suggestion set 132.

Text assistant instructions 140 may transmit suggestion set 132 to text processing extensions 110A and 110B. Text processing extensions 110A and 110B may display suggestion set 132. Text processing extensions 110A and 110B may compare suggestion set 132 to source text 130, process suggestion set 132 based on the comparison, and display suggestion set 132.

### 2.2 Program Processing Examples

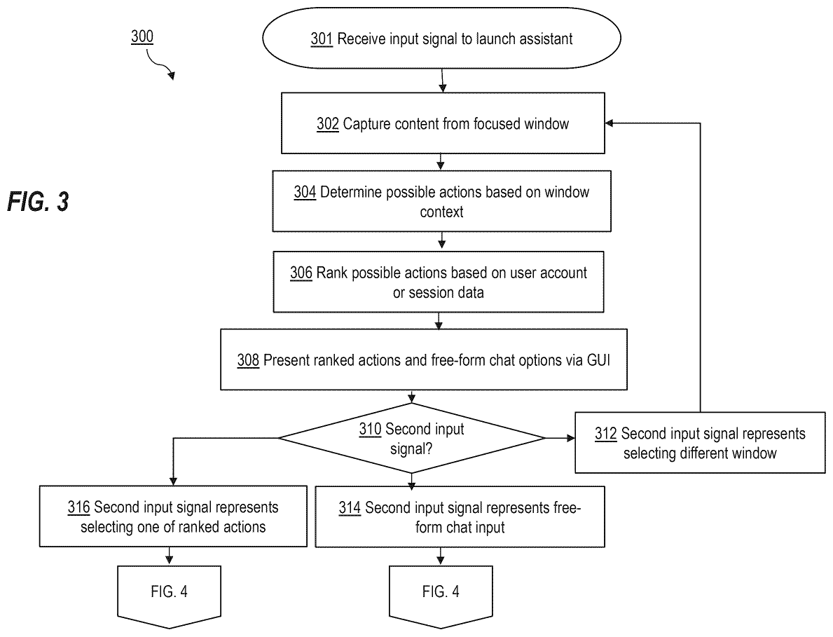

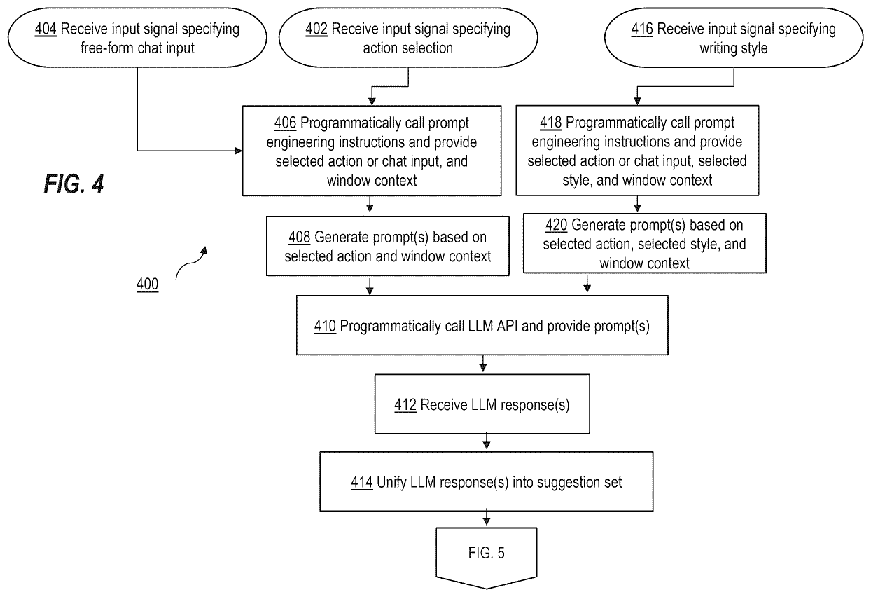

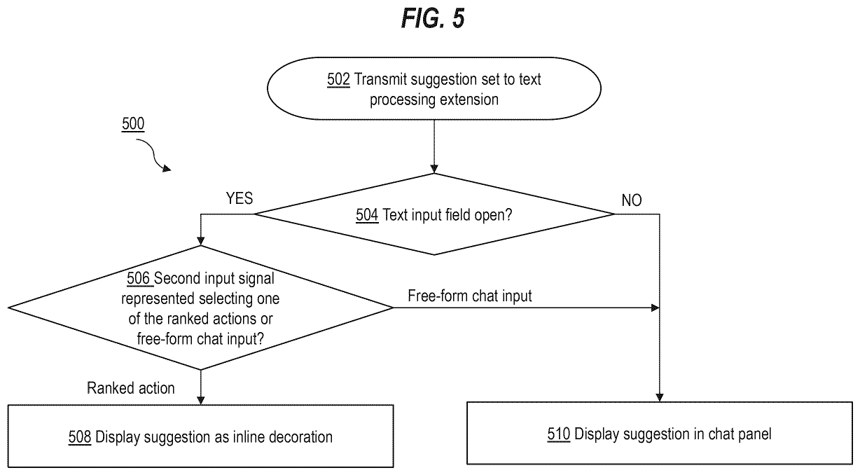

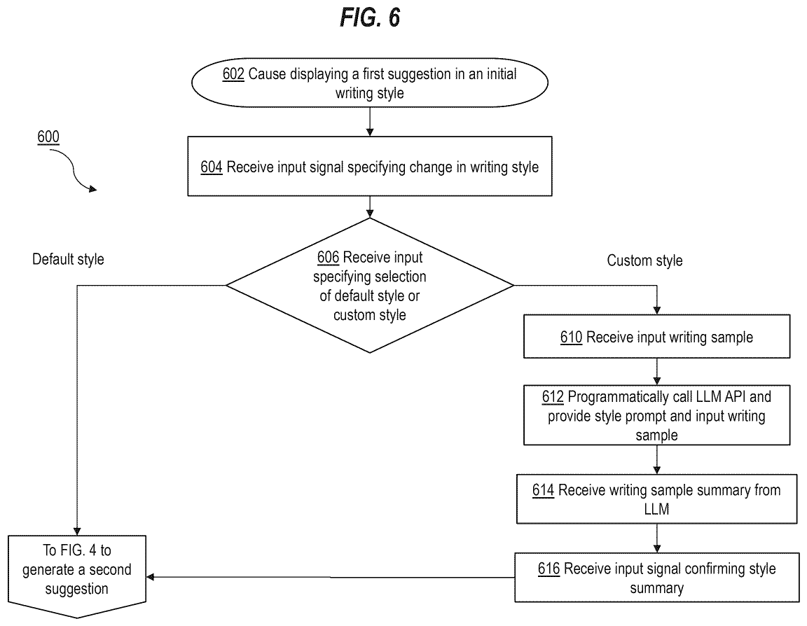

A computer system with the architecture outlined above can be configured, under stored program control, to provide generative AI-supported writing assistance in a style based on detected content from a focused application window. For one embodiment, drawing figures FIG. 3, FIG. 4, FIG. 5, and FIG. 6 outline algorithms that could be programmed, and separate sections illustrate example graphical user interfaces that could be integrated into an embodiment. FIG. 3 illustrates a computer-implemented or programmed process for displaying a ranked list of actions. FIG. 4 illustrates a computer-implemented or programmed process for generating a suggestion set. FIG. 5 illustrates a computer-implemented or programmed process for displaying a suggestion in a chat panel or as an inline decoration. FIG. 6 illustrates a computer-implemented or programmed process for generating a replacement suggestion in a selected writing style.

FIG. 3 and each other flow diagram herein is intended as an illustration of the functional level at which skilled persons, in the art to which this disclosure pertains, communicate with one another to describe and implement algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

Referring first to FIG. 3, displaying a ranked list of actions can be performed by at least one device of a computing system, as in FIG. 1, via processor-executable instructions that are stored in computer memory. To illustrate a clear example, the operations of FIG. 3 are described as performed by computer system 100, but other embodiments may use other systems, devices, or implemented techniques. One or more operations in FIG. 3 may be performed by one or more components as described in FIG. 1; for example, the text processing extensions 110A and 110B and/or text assistant instructions 140 can be programmed, using one or more sequences of instructions, to execute an implementation of FIG. 3. The various operations in FIG. 3 are presented and described sequentially, but one of ordinary skill in the art will appreciate that some or all the operations may be executed in different orders, may be combined or omitted, and some or all the operations may be executed in parallel. Furthermore, the operations may be performed actively or passively.

In an embodiment, flow 300 begins at step 301, where the process is programmed to receive an input signal from a user or client computing device such as computing device 102. The process is programmed to launch a text assistant service, program, or interface in response to receiving the input signal. For example, the computing device 102 may execute instructions to launch a text assistant interface via text processing extensions 110A and 110B.

At step 302, the flow 300 is programmed to capture content from a focused window displayed on display device 112. Typically, the content is text that has been typed, copied into, or otherwise obtained in the focused window. The flow 300 can be programmed to call an operating system service or application to obtain the content, to read a specified range of addresses of main memory that are known to store content for a focused window or to use other techniques. In one embodiment, the flow 300 is programmed to call or invoke an accessibility service or application programming interface (API) of the operating system of the computing device and to obtain content via calls to the accessibility API. Example techniques for capturing content from a focused window are described in U.S. Pat. Nos. 11,880,644 and 11,468,227, each of which is incorporated by reference herein.

Captured content may include data useful as context in other operations, such as a body of text in the focused window and/or text in a text input field in the window. Context data may also include highlighted or selected text in the focused window. Context data may also include an identifier for an application corresponding to the focused window. Context data may also include a Uniform Resource Locator (URL) for a website displayed in the focused window. Context data may also include a user account identifier. Context data may also include unselected text in the focused window and/or text that is outside an active field of the focused window (e.g., earlier emails in an email thread in which a reply is being written by the user).

By including context data outside the selected text (if any) and/or outside the active field of the focused window, subsequent operations such as tailored suggestions for improvement of the text (described below) can take all of the relevant context into consideration. For example, when helping a user write or revise a reply to an email, but the system can take the entire email thread into consideration, not just the actual reply being written. As a more specific example, if the user inadvertently addresses his reply to a person who is not the sender of the email being replied to, but who is mentioned in an earlier message in the same thread (and displayed in the focused window), the system will understand what the user meant to do and will suggest an appropriate correction.

In some embodiments, text processing extension 110A or 110B captures the entire content of the focused window while filtering out irrelevant items such as user interface controls. To do so, the text processing extension 110A or 110B may traverse a hierarchical (tree) metadata structure that is representative of the content of the focused window. For example, text processing extension 110A, which is a browser extension, may traverse a document object model (DOM) associated with the current focused window. As another example, text processing extension 110B, which is associated with another application 106, may traverse an accessibility tree associated with the operating system.

In either case, the process of traversing the tree may include extracting specific nodes, attributes and/or elements from the tree structure, while filtering out others. For example, the process may extract attributes relating to user-entered text, title, URLs, role and subrole attributes, while filtering out items such as user interface controls, style tags, scripts tags and noscripts tags. Alternatively, or in addition, the process may apply one or more heuristics to identify and extract the most important part(s) of the tree. Finally, the process may format the tree in a way to reduce LLM tokens (e.g., by converting JSON to a whitespace-delineated tree) to speed up subsequent LLM processing (described below). The result of this tree traversal process may be or include the source text 130 sent from computing device 102 to the server computer 103. In some embodiments, the above-described tree traversal may instead be performed on the server computer 103, such as by the prompt engineering instructions 150, rather than by text processing extension 110A or 110B.

Referring still to FIG. 3, at step 304, the flow 300 is programmed to determine possible actions that may be performed to provide suggestions based on the context. For example, if the context includes a URL for an email service and/or a body of text from an email, actions may include “reply to email,” “summarize email thread,” or “improve email draft.” In another example, if the context includes a document, actions may include “summarize the document” or “improve selected text” within the document. In an embodiment, the flow 300 is programmed to identify and cause displaying graphical user interface (GUI) widgets corresponding to and labeled with the available actions; GUI examples that could be used are described in other sections in relation to other drawing figures. The possible actions are hard-coded in one embodiment, stored in configuration data, or otherwise statically determined. In another embodiment, the possible actions are determined by executing the inference stage of a trained machine-learning model over the context data to result in output classifications or predictions of possible actions, which can be used directly or mapped to a subset of actions for which other program logic has been programmed.

At step 306, flow 300 is programmed to rank the possible actions. In various embodiments, the actions may be ranked based on user account or session data. For example, if user account data does not include a history of using a particular service, actions related to that service will be ranked lower. In another example, if a user frequently selects the favorite action, the favorite action may be ranked higher. Actions may also be ranked based on data collected from multiple user accounts. For example, if user account activity for multiple users indicates an action is selected more often, the action may be ranked higher. In an embodiment, the ranking operations may be executed by computing device 102 via text processing extensions 110A and 110B.

In another embodiment, the context and user account or session data may be transmitted to text assistant instructions 140, which may rank the actions based on the context and user account or session data. Prompt engineering instructions 150 may include a prompt and prompt logic for engineering an action ranking request prompt. Text assistant instructions 140 may call LLM API with the action ranking request prompt to rank the possible actions.

At step 308, flow 300 is programmed to present the ranked actions as selectable options or widgets via a GUI. The GUI may include a first widget programmed to select or provide a free form chat input option. The Flow 300 may be programmed to cause the GUI to display a limited set of widgets corresponding to ranked actions; for example, the GUI may only display the first widget for free-form chat input and/or other widgets for the top two, three or four ranked actions. The GUI may display widgets for a single action or four or more actions. The GUI may include a scroll functionality to display one, two, three, or four ranked actions from a list of actions at a time. The GUI may display an option or an icon for receiving input instructing the assistant to select another focused window or attach a different document.

At step 310, flow 300 is programmed to receive a second input signal. The second input signal may be received via input device 114. The second input signal may represent selecting a widget corresponding to one of the ranked actions, a free-form text or chat input, or selecting or attaching a different window or document.

At step 312, if the second input signal represents selecting or attaching a different window or document, flow 300 is programmed to return control to step 302. The flow 300 is programmed then to rank actions based on the different window or document and present them via the GUI.

At step 316, if the second input signal represents selecting one of the ranked actions, the flow 300 may be programmed to cause the text processing extensions 110A and 110B to send the selected action, the context, and a user account identifier to text assistant instructions 140 and prompt engineering instructions 150. The flow 300 may continue executing at step 401 of flow 400 in FIG. 4.

At step 318, if the second input signal represents a free-form text or chat input, flow 300 is programmed to cause the text processing extensions 110A and 110B to send the free-form text or chat input, the context, and a user account identifier to text assistant instructions 140 and prompt engineering instructions 150. The process may continue execution at step 404 of flow 400 in FIG. 4.

FIG. 4 illustrates a computer-implemented or programmed process for generating a suggestion set. In various embodiments, executing flow 400 may begin at steps 401, 404, or 416. The operations of a flow 400, as shown in FIG. 4, can be implemented using processor-executable instructions that are stored in computer memory. For purposes of providing a clear example, the operations of FIG. 4 are described as performed by computer system 100, but other embodiments may use other systems, devices, or implemented techniques. One or more operations in FIG. 4 may be performed by one or more components as described in FIG. 1; for example, text assistant instructions 140 can be programmed, using one or more sequences of instructions, to execute an implementation of FIG. 4. While the various operations in FIG. 4 are presented and described sequentially, one of ordinary skill in the art will appreciate that some or all the operations may be executed in different orders, may be combined or omitted, and some or all the operations may be executed in parallel. Furthermore, the operations may be performed actively or passively.

At step 402, the flow 400 is programmed to receive an input signal specifying an action selection. The selected action may be one of the ranked actions. At step 404, the assistant may receive an input signal specifying a free-form text or chat input.

At step 406, flow 400 may call prompt engineering instructions 150 and provide prompt engineering instructions 150 with the context and/or a user account identification. If the second input signal specifies an action selection, the flow 400 may also provide the prompt engineering instructions 150 with the action selection. If the second input signal specifies free-form text or chat input, the assistant may also provide the prompt engineering instructions 150 with the free-form text or chat input.

At step 408, the assistant may generate one or more prompts for a large-language model (LLM). The prompt engineering instructions 150 may comprise a database, flat file system, object store, or another digital data repository that stores actions 154A, 154B, 154C. Each stored action may include one more action-specific prompts 156A, 156B, 156C and prompt logic 158A, 158B, 158C. If the selected action corresponds to a stored action, the prompt engineering instructions 150 may generate one or more prompts by selecting the action-specific prompts. Prompt engineering instructions 150 may generate one or more LLM prompts by applying the prompt logic to the action-specific prompts to add additional information from the context to the prompts as specified by the prompt logic. The generated prompts may include instructions for the LLM to select a writing style based on the context and the selected action. If the second input signal specifies free-form text or chat input, the prompt engineering instructions may generate one or more LLM prompts by modifying the free-form text or chat input based on a general-use prompt logic to prepare the one or more LLM prompts.

In an embodiment, at step 416, text assistant instructions 140 may receive a signal specifying a writing style to use. At step 418, text assistant instructions 140 may programmatically call prompt engineering instructions 150 with the context, the specified writing style and/or a user account identification. Text assistant instructions 150 may be programmed to provide prompt engineering instructions 150 with a writing sample in the specified writing style. The writing sample may be selected from a set of writing samples in various writing styles. The set of writing samples may be stored in memory of the text assistant instructions 140. In an embodiment, text assistant instructions 150 may be programmed to provide prompt engineering instructions 150 with a custom writing sample. Text assistant instructions 140 may have received the custom writing sample from text processing extensions 110A and 110B with the input signal specifying a writing style. In an embodiment, the signal specifying a writing style may also specify an action selection, free-form text, or chat input, which the assistant may also provide to the prompt engineering instructions.

At step 420, the text assistant instructions 140 may be programmed to generate one or more prompts for an LLM based on the context, the specified writing style, and the action selection or free-form text or chat input. The prompts may be generated as described in step 408. In some embodiments, the tree traversal process described above in connection with step 302 may instead be performed by the prompt engineering instructions 150 in step 408 or step 420, rather than by text processing extension 110A or 110B. In some embodiments, the pruned reformatted tree (i.e., the full whitespace-formatted text, not a digest or summary) is sent as is to the LLM wrapped in XML-like tags, for example, as follows:

```
// For DOM trees
if (appContexts.domTree) {
  inputItems.push({
    role: ′user′,
    content: ‘<screenInformation>${appContexts.domTree}</screenInformation>‘,
    id: newMsgId(InputKind.DomTree),
  });
}
// For AX trees
if (appContexts.axTree) {
  inputItems.push({
    role: ′user′,
    content: ‘<screenInformation>${appContexts.axTree}</screenInformation>‘,
    id: newMsgId(InputKind.AxTree),
  });
}
```

In some embodiments, the prompt to the LLM includes multiple separate user messages, such as a separate user message for each of: 1) user-selected text (if any), 2) the full AX or DOM tree (whitespace-formatted), 3) any file attachments, and 4) the user's actual prompt (i.e., the request/question itself). For example, the LLM might see the following:

```
[user message 1]: <screenInformation>
  Search
    Focused
    Other
      Sent
</screenInformation>
[user message 2]: <selectedText>Please review this document</selectedText>
[user message 3]: Improve this text
```

The prompt engineering instructions 150 may include an evaluation prompt. The evaluation prompt may be used to instruct an LLM to determine whether a suggestion response to the selected action or free-form chat input should include multiple alternative suggestions or a single straightforward answer suggestion. In an embodiment, the multiple alternative suggestions may be different ways to perform a selected action. For example, if a signal indicating an “improve selected text” is received, the multiple alternative suggestions may include “fixed spelling,” “clearer wording,” and “more technical.”

Below is one example of an evaluation prompt included in prompt engineering instructions 150.

```
deftemplate user_input
“““
{{ userPrompt }}
”””
defun schema_definition
{
    “type”: “object”,
    “properties”: {
      “artifact thinking”: {
        “type”: “string”,
        “description”: “Instructions relating to the thought process related to
deciding on and potentially creating an artifact.”,
      } ,
      “mode”: {
        “type”: “string”,
        “enum”: [“artifact”, “non_artifact”],
        “description”: “Defines whether the response should be in artifact mode or
non-artifact mode.”
      },
      “artifact mode”: {
        “type”: [“object”, “null”],
        “description”: “- Used when the user's request requires creating an
artifact.\n- The response will include a detailed artifact that addresses the user's writing request.”,
        “properties”:
          “acknowledgement”:
            “type”: “string”,
            “description”: “A paraphrase of the user's
request.”
          },
          “message type”: {
            “type”: “string”,
            “enum”: [“slack message”, “email”, “report”, “social media
post”, “business proposal”, “blog article”, “press release”, “presentation”, “code sample”,
“other”],
            “description”: “Specifies the type of message being crafted,
such as a Slack message or an email.”
          },
          “writing style”: {
            “type”: “string”,
            “enum”: [“friendly”, “enthusiastic”, “straightforward”,
“formal”],
            “description”: “Specifies the writing style to be used in the
response. Select the appropriate style for the type of communication.”
          },
          “ideation approaches” {
            “type”: “array”, “items”:
            “type”: “string”
            },
            “description”: “This field provides three distinct methods or
strategies for constructing the requested document, tailored to different tonalities, perspectives,
or goals. These approaches offer varied ways to address the document's purpose, ensuring
adaptability to the user's needs.”
          },
          “length”: {
            “type”: “integer”,
            “description”: “Specifies the desired length of the response
in the number of words.”
          },
          “audience”: {
            “type”: “string”,
            “description”: “target audience for the message,
e.g. ‘engineering team’, ‘marketing team’, ‘customer’, etc”
          },
          “artifact id”: {
            “type”: “string”,
            “description”: “Unique identifier for the artifact, formatted
in kebab-case. [May specify a limit on token length.]”
          },
        },
        “required”: [
          “acknowledgement”,
          “message_type”,
          “writing_style”,
          “ideation_approaches”,
          “length”,
          “audience”,
          “artifact_id”
        ],
        “additionalProperties”: false
      },
      “non_artifact_mode”: {
        “type”: [“object”, “null”],
        “description”: “- Used when the user's request does not require an artifact
but rather a straightforward answer.\n- This mode is ideal for simple queries or when the user
needs a quick, clear response.”,
        “properties”: {
          “response_thinking”:
            “type”: “string”,
            “description”: “The thought process or rationale behind the
answer.”
          },
          “response_content”: {
            “type”: “string”,
            “description”: “The answer to the user's question.”
          }
        },
        “required”: [“response_thinking”, “response_content”] ,
        “additionalProperties”: false
      }
    },
    “required”: [“artifact_thinking”, “mode”, “artifact_mode”, “non_artifact_mode”],
    “additionalProperties”: false
defun response_format_structured_output
{
“type”: “json_schema”,
    “json_schema”:
    “name”: “artifact_or_not_response_schema”,
      “strict”: true,
      schema: schema_definition( )
    }
}
defun response_format_function_calling
{
    “name”: “artifact_or_not”,
    “description”: “Determines whether to produce an artifact based on the user's request and
provides the relevant response.”,
    “parameters”: schema_definition( )
}
defun prompt_meta
if f(isStructuredOutput,
    { generation_parameters: { response_format:
response_format_structured_output( ) } },
    { functions: [ response_format_function_calling( ) ],
function call: “artifact_or_not” })
defprompt main
@meta: prompt_meta({ isStructuredOutput })
{
  if f(is defined(require_setup) and require_setup,
    g2 assistant::setup({ ax tree, vbar_whole text,
vbar active_paragraph }),
    [ l ) ,
    { role: “user”, content: user_input({ userPrompt }) }
]
```

The prompt engineering instructions 150 may include an ideation tab creation prompt accessible using a GUI widget. If multiple alternative suggestions are appropriate for the suggestion response, then the ideation tab creation prompt may be programmed to produce tab titles and brief tab descriptions that may be produced alongside each of the multiple alternative suggestions to describe how each alternative suggestion differs from the other alternative suggestions.

The following is one example of an ideation tab creation prompt included in Prompt engineering instructions:

```
deftemplate user_input
“““
---- USER PROMPT ---
“{{ userPrompt }}”
---- ATTRIBUTES ----
artifact id: “{{ artifact_id }}”
message type: “{{ message_type }}”
ideation approach: “{{ ideation_approach }}”
length: “{{ length }}”
audience: “{{ audience }}”
{% if var or default(“apply_writing style”,“false”) ==“true”%}
When generating the artifact content, use a style similar to the given
writing style:
writing style overview: “{{ writing_style_overview}}”
writing style sample: “{{ writing_style_samples }}”
{% end %}
”””
defun schema_definition
{
    “type”: “object”,
    “properties”: {
      “ideation”: {
        “type”: “string”,
        “description”: “Think what makes ‘{{ ideation_approach}}’ approach
different from {{ alternative_approaches }}. ”
      },
      “thinking”: {
        “type”: “string”,
        “description”: “Think what the artifact should look like.
Focus on what could make it stand out to highlight the specified ideation approach.”
      },
      “content”: {
        “type”: “string”,
        “description”: “The main body of the artifact. It is a response that
addresses the user's writing request.”
      },
      “commentary”: {
        “type”: [“string”, “null”],
        “description”: “After generating the artifact, provide additional context or
explanation in this section. This commentary helps the user understand the artifact's purpose or
content. Style can be specified.”
      },
    }
    “required”: [“ideation”, “thinking”, “content”, “commentary”],
    “additionalProperties”: false
defun response_format_structured_output
{
    “type”: “json_schema”,
    “json_schema”:
      “name”: “artifact_response_schema”,
      “strict”: true,
      schema: schema_definition( )
    }
}
defun response_format_function_calling
{
  “name”: “artifact”,
“description”: “Determines whether to produce an artifact based on the user's request and
provides the relevant response.”,
“parameters”: schema_definition( )
}
defun prompt_meta
if_f(isStructuredOutput,
    { generation_parameters: { response_format:
response_format_structured_output( ) } },
    { functions: [ response_format_function_calling( ) ],
function call: “artifact” })
defprompt main
@meta: prompt_meta({ isStructuredOutput })
[
  if_f(is_defined(require_setup) and require_setup,
  g2 assistant::setup({ ax_tree, vbar_whole text,
vbar active_paragraph }),
  [ ] ) ,
  { role: “user”, content: user_input({ artifact_id, message_type, ideation_approach, length,
audience, apply_writing style,
writing_style_samples, writing_style_overview, userPrompt })
]
```

At step 410, the text assistant instructions 140 are programmed to programmatically call the LLM API 160 using one or more prompts. For example, the text assistant instructions 140 are programmed to generate a request directed to an endpoint of an LLM, in which one parameter is a request type and another parameter is the prompt of step 408. Step 410 may comprise calling the LLM API 160 separately for each prompt generated at step 408. In another embodiment, text assistant instructions 140 may be programmed to merge multiple generated prompts into a single prompt for calling the LLM API 160.

At step 412, the text assistant instructions 140 are programmed to receive the LLM responses to the one or more prompts. At step 414, the text assistant instructions 140 are programmed to unify the received responses with response unifier instructions 170 into suggestion set 132 At this point, the process of FIG. 4 can continue as described with flow 500 of FIG. 5, starting at step 502.

FIG. 5 illustrates a computer-implemented or programmed process for displaying a suggestion in a chat panel or as an inline decoration. The operations of a flow 500, as shown in FIG. 5 can be implemented using processor-executable instructions that are stored in computer memory. For purposes of providing a clear example, the operations of FIG. 5 are described as performed by computer system 100, but other embodiments may use other systems, devices, or implemented techniques. One or more operations in FIG. 5 may be performed by one or more components as described in FIG. 1; for example, text assistant instructions 140 can be programmed, using one or more sequences of instructions, to execute an implementation of FIG. 5. While the various operations in FIG. 5 are presented and described sequentially, one of ordinary skill in the art will appreciate that some or all the operations may be executed in different orders, may be combined or omitted, and some or all the operations may be executed in parallel. Furthermore, the operations may be performed actively or passively.

At step 502, text assistant instructions 140 transmit suggestion set 132 to text processing extensions 110A and 110B. At step 504, text processing extensions 110A and 110B are programmed to determine whether a text input field is open in the focused window. If a text input field is not open, the process is programmed to move to step 510, and the suggestion set may be displayed in a GUI chat panel that presents ranked actions and free-form chat options via GUI in step 308. In another embodiment, the suggestion set may be displayed in a new GUI window or in a different existing GUI window.

If a text input field is open at step 504 of the process, the process may continue to step 506. At step 506, the text processing extensions 110A and 110B are programmed to determine if the second input signal from step 310 represented selecting one of the ranked actions or free-form chat input. In an embodiment, the text processing extensions 110A and 110B are programmed to store a variable representing the second input signal from step 310. In another embodiment, suggestion set 132 may include data indicating the second input signal used to generate suggestion set 132.

If the second input signal from step 310 represents selecting free-form chat input, the process may be programmed to continue to step 510, and the suggestion set may be displayed in a GUI chat panel that presents ranked actions and free-form chat options via GUI in step 308. In another embodiment, if the second input signal from step 310 represents selecting free-form chat input, the suggestion set may be displayed in a new GUI window or in a different existing GUI window.

If the second input signal from step 310 represents selecting one of the ranked actions, the process may continue to step 508, and the suggestion set may be displayed as inline decoration. The text processing extensions 110A and 110B are programmed to compare text in the focused window to text in the suggestion set. The text processing extensions 110A and 110B are programmed to generate decorated mark-up text that indicates differences between the text in the focused window and text in the suggestion set. In an embodiment, characters, words, or phrases added in the suggestion set may be underlined or highlighted in a first color in the decorated markup text. In an embodiment, characters, words, or phrases in the focused window text but not in the suggestion set text may be struck through or highlighted in a second color in the decorated markup text. The text processing extensions 110A and 110B may signal the focused window via browser 108 or application 106 to replace the focused window text with the decorated mark-up text.

In another embodiment, the text processing extensions 110A and 110B are programmed to display the decorated mark-up text in a GUI chat panel that presents ranked actions and free-form chat options via GUI in step 308.

In another embodiment, the text processing extensions 110A and 110B are programmed to check and measure similarity between suggestion set 132 and text in the text input field. If the similarity falls below a threshold, the process may continue to step 510, and the suggestion set may be displayed in a GUI chat panel that presents ranked actions and free-form chat options via GUI in step 308. In another embodiment, if similarity falls below the threshold, the suggestion set may be displayed in a new GUI window or in a different existing GUI window. If the similarity is above a threshold, the process may continue to step 508, and the text processing extensions 110A and 110B are programmed to generate a decorated mark-up text that indicates differences between the text in the focused window and text in the suggestion set. The generated markup text may be displayed in the focused window or in a GUI chat panel.

FIG. 6 illustrates a computer-implemented or programmed process for generating a replacement suggestion in a selected writing style. The operations of a flow 600, as shown in FIG. 6 can be implemented using processor-executable instructions that are stored in computer memory. For purposes of providing a clear example, the operations of FIG. 6 are described as performed by computer system 100, but other embodiments may use other systems, devices, or implemented techniques. One or more operations in FIG. 6 may be performed by one or more components as described in FIG. 1; for example, text processing extensions 110A,110B, and text assistant instructions 140 can be programmed, using one or more sequences of instructions, to execute an implementation of FIG. 6. While the various operations in FIG. 6 are presented and described sequentially, one of ordinary skill in the art will appreciate that some or all the operations may be executed in different orders, may be combined or omitted, and some or all the operations may be executed in parallel. Furthermore, the operations may be performed actively or passively.

Flow 600 begins with step 602 in which a first suggestion in an initial writing style is displayed. The first suggestion may be displayed as inline decoration or in a chat panel, as described in steps 508 and 510. At step 604, the text processing extensions 110A and 110B may receive a signal specifying a change in writing style. At step 606, the text processing extensions 110A and 110B may receive a writing selection signal specifying a selection of one of several default writing styles, a stored custom writing style, or a new custom writing style. If the writing selection signal specifies a selection of one of several default writing styles or a stored custom writing style, then the process may move to step 416 of FIG. 4.

If the writing selection signal specifies a selection of a new custom writing style, then the process may move to step 610. Text processing extensions 110A and 110B may receive an input writing sample. Text processing extensions 110A and 110B may transmit the input writing sample to text assistant instructions 140. In an embodiment, the received input writing style may be stored in computer memory of computing device 102 and/or server computer 103. In an embodiment, multiple custom writing styles may be stored in computer memory. Text assistant instructions 140 may programmatically call prompt engineering instructions 150 to generate a writing style analysis prompt for the LLM APL The writing style analysis prompt for the LLM API may request a summary of the input writing style. At step 612, text assistant instructions 140 may programmatically call LLM API 160 with the writing style analysis prompt and the input writing sample.

At step 614, text processing extensions 110A and 110B are programmed to receive a writing sample summary generated by the LLM. Text processing extensions 110A and 110B are programmed to receive the writing sample summary from text assistant instructions 140, which may have received the writing sample summary from the LLM. The writing sample summary may be displayed in GUI on computing device 102. At step 616, Text processing extensions 110A and 110B are programmed to receive a user input confirmation signal confirming the style summary is the style that should be used as a custom style. The process may continue to step 416 of FIG. 4.

### 2.3 Graphical User Interface Examples

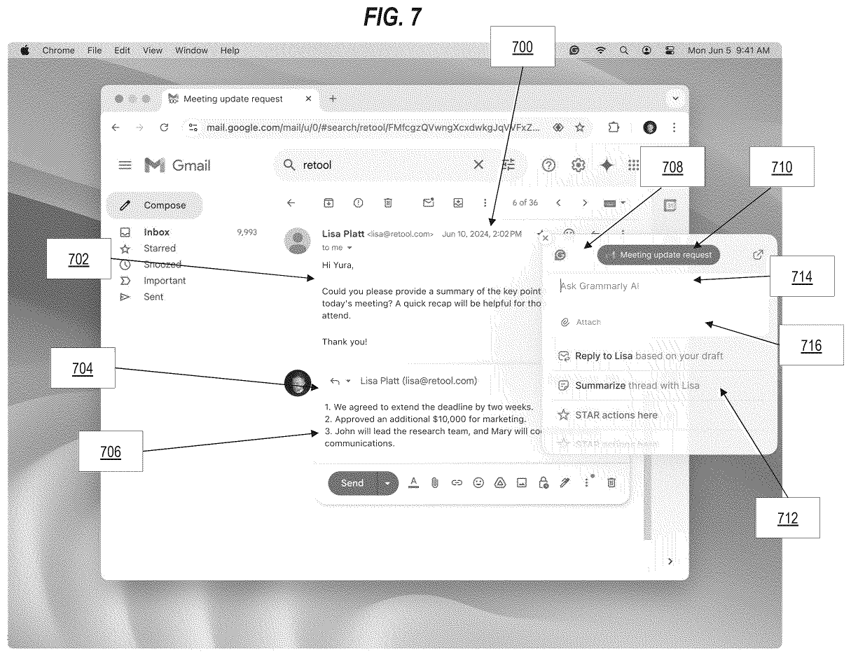

FIG. 7 illustrates an example of a graphical user interface of a browser window with an electronic mail (email) client with which an embodiment can be used. In FIG. 7, a GUI window 700 is displayed in the ordinary operation of an application program, browser, or other program executed on a computer, such as a mobile computing device. In an embodiment, a browser running with GUI window 700 provides electronic mail (email) composing functions. The GUI window displays a first email 702 from a sender. The GUI has instantiated a sub-window 704, which shows, in FIG. 7, a portion of a second email undergoing the composition of a reply to the first email. The sub-window includes a Recipients list and a source text unit 706.

In an embodiment, the text assistant instructions 140 are programmed to display a launch widget, which can be graphically rendered as a small white vertical bar or notch superimposed over a right margin of the display screen. In response to user input specifying the selection of the notch, the text assistant instructions 140 are programmed to display an assistant widget, which can be visually rendered as a colored graphical icon of a specified size, shape, and decoration. In response to a selection of the assistant widget, the text assistant instructions 140 are programmed to instantiate an assistant panel or window to represent a text assistant.

In an embodiment, an assistant GUI 708 is launched automatically and comprises a title bar 710 with a value extracted from the first email's subject line. In the example of FIG. 7, the value of title bar 710, “Meeting update request,” has been obtained via accessibility API calls that identify the position and content of the subject line of the email message shown in the other windows. In another embodiment, the title bar 710 may be extracted from text unit 706 or any other text in the GUI window 700.

In an embodiment, the assistant GUI 708 is programmed to display a ranked list of actions 712, a free-form chat input panel 714, and a window or document attachment widget 716. In an embodiment, the ranked list of actions 712 is determined as described above for FIG. 3 and FIG. 4. In the example of FIG. 7, the actions in the ranked list of actions 712 comprise “Reply to Lisa” and “Summarize” Each of the actions is programmed as an active, selectable hyperlink which, when selected, causes the text assistant instructions 140 to execute the specified action. For example, user input to select “Reply to Action” will cause the text assistant instructions 140 to generate the text of a reply to the sender of the email by programmatically calling an LLM API using the context data represented in the email windows or by executing the inference stage of a trained machine learning model over the content of the email windows. Similarly, in response to user input to select the “Summarize” action, the text processing instructions 140 are programmed to cause generating a summary of the email in first email 702 by calling an LLM API with a summarization prompt and providing the contents of the window as added input data or context. In an embodiment, an LLM API may be called with a prompt and content or context as described above for FIG. 3 and FIG. 4. The free-form chat input panel 714 is programmed as an active text input field that can receive arbitrary typed or pasted text from a user computer and/or a file attachment, then act on the text and/or file by using a machine learning model to generate new or modified text automatically or by calling an LLM API using the text and/or the context data represented in the email windows. In an embodiment, the document attachment widget 716, may, when selected execute instructions causing the text processing extension to refresh the GUI window based on text from a different window via accessibility API calls that identify the position and content of the text from a different window. In an embodiment, different window content may be selected and the GUI may display a different tile bar 710 and ranked lists of actions 712 as described above for FIG. 3.

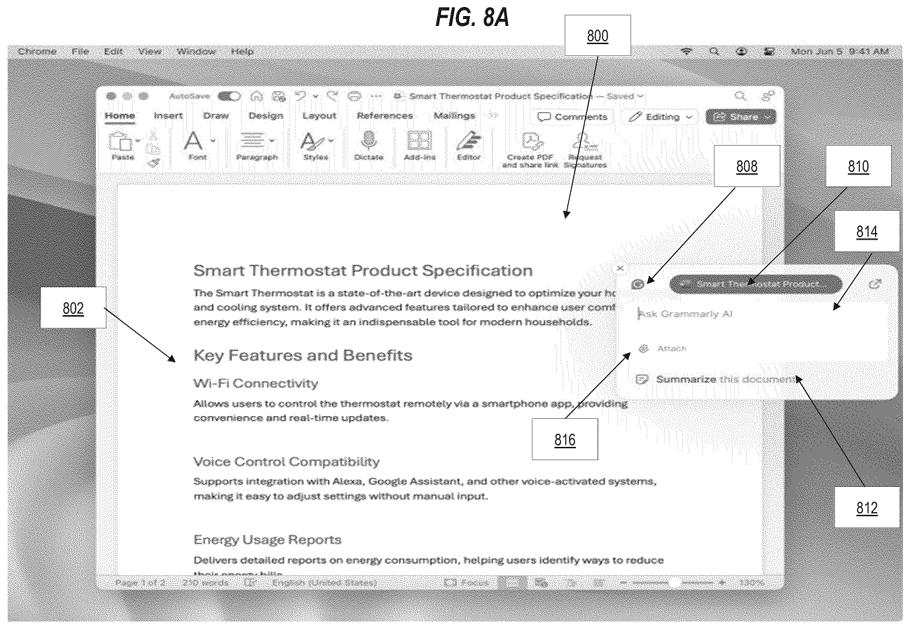

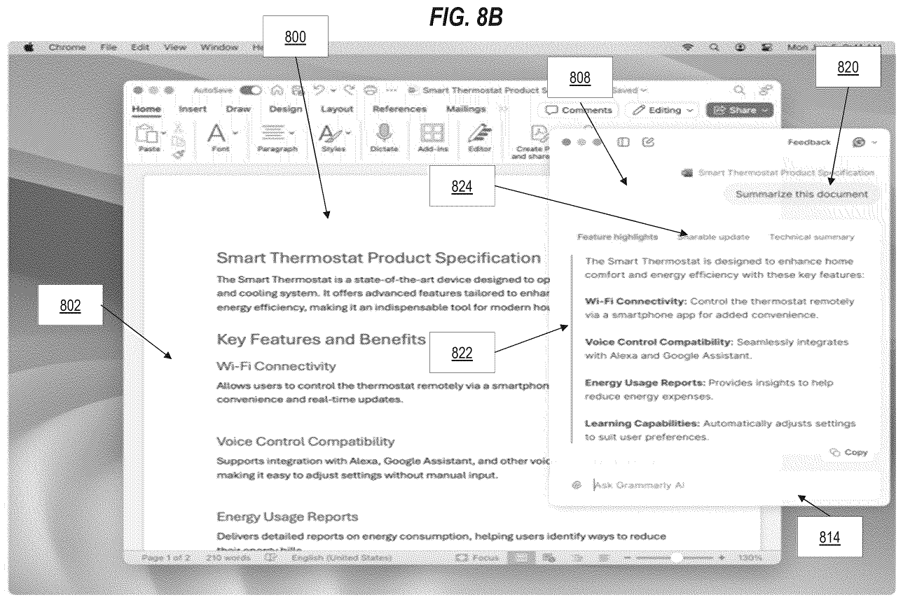

FIG. 8A illustrates an example of a graphical user interface that may be programmed to display an action in conjunction with an application. In FIG. 8A, a GUI window 800 is displayed in the ordinary operation of an application program, browser, or other program executed on a computer, such as a mobile computing device. In an embodiment, a word processing application running with GUI window 800 includes a word processing text field 802. An assistant GUI 808 is displayed with a title bar 810. In the example of FIG. 8A, the value of title bar 810, “Smart Thermostat Product Specification” has been obtained via accessibility API calls that identify the position and content of the title of a document opened by the word processing application. In the example of FIG. 8A, a portion of the value of title bar 810 is displayed as “Smart Thermostat Product . . . ” to fit within space constraints of GUI window 800. In other embodiments, an entire title may be displayed in title bar 800.

In an embodiment, the assistant GUI 808 is programmed to display action widget 812, a free-form chat input 814, and a window or document attachment button 816. In an embodiment, the action widget 812 is selected as described above for FIG. 3 and FIG. 4. In the example of FIG. 8A, the action widget comprises “Summarize this document.” Action widget 812 is programmed as an active, selectable hyperlink which, when selected, causes the text assistant instructions 140 to execute the specified action. For example, in response to user input to select the “Summarize this document” action, the text processing instructions 140 are programmed to cause generating a summary of the document opened by the word processing application by calling an LLM API with a summarization prompt and providing the contents of the window as added input data or context. The free-form chat input panel 814 is programmed as an active text input field that can receive arbitrary typed or pasted text from a user computer and/or a file attachment, then act on the text and/or file using a machine learning model to generate new or modified text automatically. In an embodiment, an LLM API may be called with a prompt and content or context as described above for FIG. 3 and FIG. 4.

FIG. 8B illustrates an example of a graphical user interface that may be programmed to display multiple alternative approaches with labeled tabs in conjunction with an application. In FIG. 8B, a word processing application running with GUI window 800 includes a word processing text field 802. Assistant GUI 808 is displayed in a response mode. Assistant GUI 808 shows input action 820, which may be an action selected in response to user input, and response 822 which may be generated in response to the action selected in response to user input. In an embodiment, the response may be generated as described above for FIG. 3 and FIG. 4. In the example of FIG. 8B, the action selected is “summarize this document.” In an embodiment, the text processing instructions 140 are programmed to cause generating a response by calling an LLM API with the contents of the window as added input data or context and with one or multiple prompts engineered to produce multiple alternative responses. Assistant GUI window 808 also includes ideation tabs 824, which indicate the multiple alternative responses to the input action 820 that may be selected. In the example of FIG. 8B, three alternative responses have been generated with different approaches to summarizing the document, including “feature highlights,” “shareable update,” and “technical summary.” The assistant GUI 808 also includes free-form chat input 814, which may be programmed as an active text input field as described above for FIG. 8A.

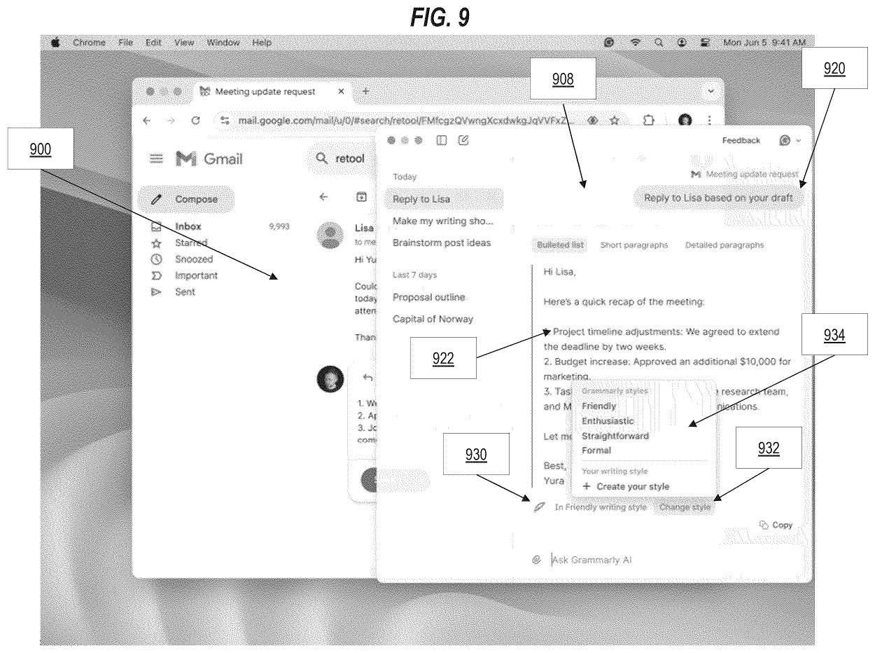

FIG. 9 illustrates an example of a graphical user interface that may be programmed to display a list of writing styles in conjunction with an application. In FIG. 9, a GUI window 900 is displayed in the ordinary operation of an application program, browser, or other program executed on a computer, such as a mobile computing device. In an embodiment, a browser running with GUI window 900 provides electronic mail (email) composing functions. An assistant GUI 908 is displayed in a response mode. Assistant GUI 908 shows input action 920, which may be an action selected in response to user input, and response 922 which may be generated in response to the action selected in response to user input. In the example of FIG. 9, the action selected is “Reply to Lisa based on your draft.”

In an embodiment, the assistant GUI 908 is programmed to display style indicator 930, “change style” button 932, and style options 934. In the example of FIG. 9, Style indicator 930 displays that the response is written in a friendly writing style, and style options 934 display options for “Friendly,” “Enthusiastic,” “Straightforward,” and “Formal” default styles. Style options 934 also displays an option to “Create your style.” In an embodiment, style options 934 are presented as described above for FIG. 6.

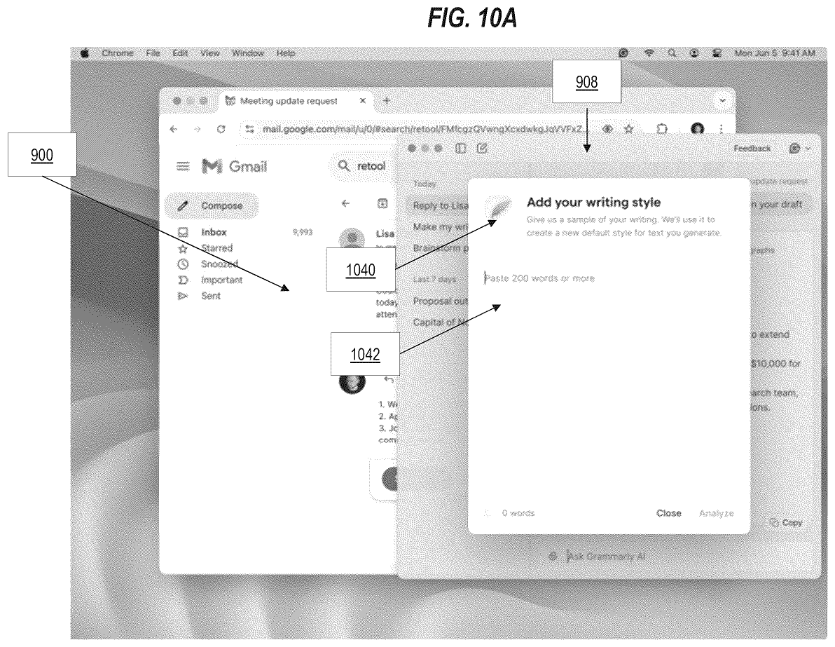

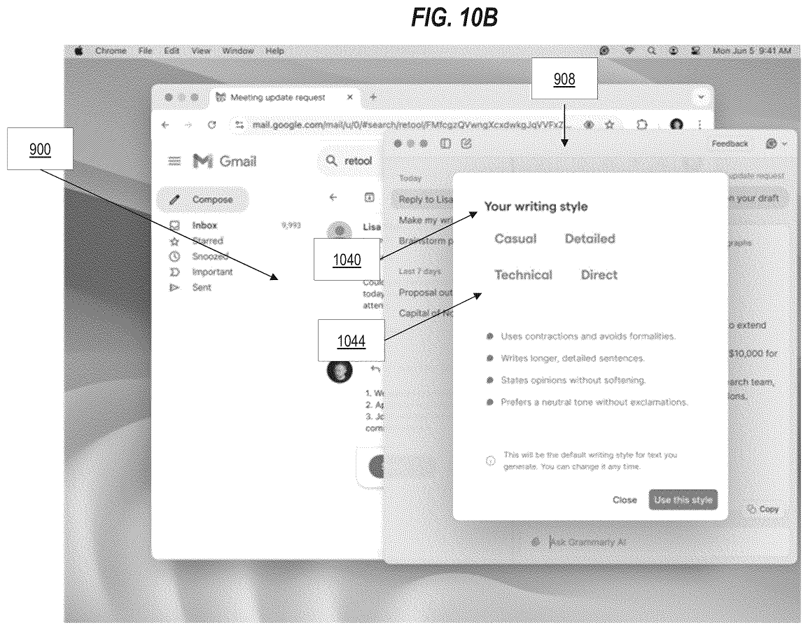

FIGS. 10A and 10B illustrate an example of a graphical user interface that may be programmed to display an input field for a custom writing style in conjunction with an application. In FIG. l0A, GUI window 900 is displayed in the ordinary operation of an application program, browser, or other program executed on a computer, such as a mobile computing device. In an embodiment, a browser running with GUI window 900 provides electronic mail (email) composing functions. An assistant GUI 908 is displayed in a response mode. Assistant GUI is programmed to instantiate a “pop-up” GUI 1040 that is programmed to display a writing sample input field 1042 in which a writing sample may be entered to create a custom writing style and an “Analyze” button. In the example of FIG. l0A, writing sample input field 1042 is displayed under the heading “Add your writing style.” Writing sample input field 1042 is programmed as an active text input field that can receive arbitrary typed or pasted text from a user computer and/or a file attachment. In response to receiving user input selecting the “Analyze” button, the text processing instructions 140 are programmed to cause generating a style analysis of the text in the writing sample input field 1042 by calling an LLM API with the text and a style analysis prompt. In an embodiment, the LLM API may be called with text and the style analysis prompt as described above for FIG. 6. In FIG. 10B, the assistant GUI 908 is programmed to instantiate a “pop-up” GUI 1040 that is programmed to display a style analysis message 1044 in response to a received writing sample. In an embodiment, style analysis message 1044 may provide a list of words that describe the submitted writing style, along with several longer phrases explaining features of the writing style. In the example of FIG. 10B, a writing style input is summarized under heading “Your writing style” and with a list of words comprising “Casual,” “Detailed,” “Technical,” and “Direct.” The writing style input, analysis, and display may be executed as described above for FIG. 6.

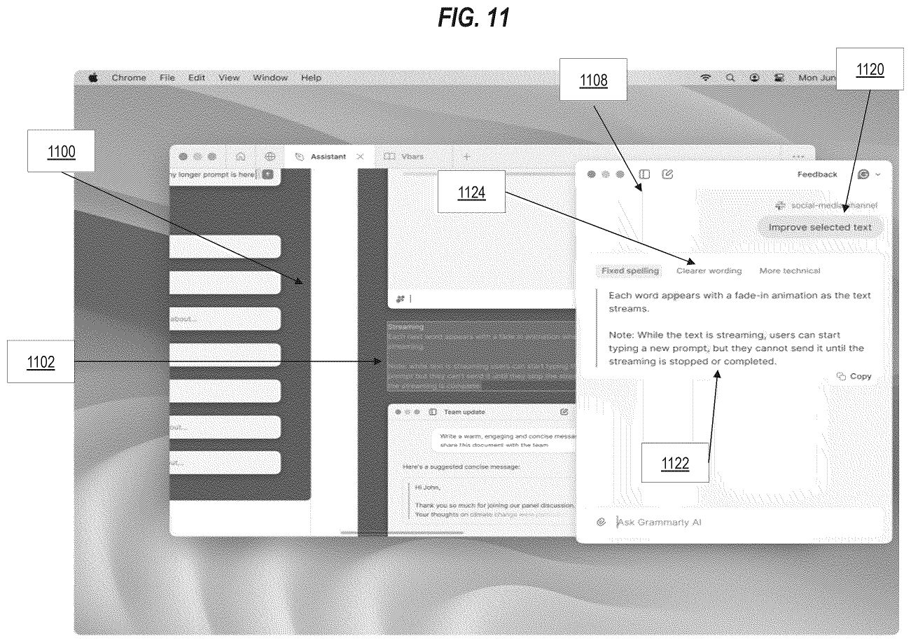

FIG. 11 illustrates an example of a graphical user interface that may be programmed to display a suggestion in an inline decoration in conjunction with an application. In FIG. 11, a graphical user interface (GUI) window 1100 is displayed in the ordinary operation of an application program, browser, or other program executed on a computer, such as a mobile computing device. GUI window 1100 is programmed to display a selected text field 1102. In the example of FIG. 11, Assistant GUI 1108 is displayed in a response mode. Assistant GUI 1108 shows input action 1120, which may be an action selected in response to user input, and response 1122 which may be generated in response to the action selected. In the example of FIG. 11, the action selected is “Improve selected text,” and the generated response is displayed with decorated marked-up text. In an embodiment, decorated marked-up text response 1122 includes highlighted letters and punctuation to correct spelling and improve grammar in the selected text. In the example of FIG. 11, the generated response includes a spelling correction provided with a highlighted “p” character in the word “appears,” and two grammar improvements with highlighted added commas after the words “streaming” and “prompt.” In an embodiment, text assistant instructions 140 generate response 1122 by programmatically calling an LLM API using the context data represented in the GUI window 1100 and selected text field 1102 or by executing the inference stage of a trained machine learning over the context data represented in the GUI window 1100 and selected text field 1102. In an embodiment, response 1122 may be generated as described above for FIG. 3 and FIG. 4 and displayed as described above for FIG. 5.

### 3. Implementation Example-Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques according to program instructions in firmware, memory, other storage, or a combination. Such computing devices may also combine custom hard wired logic, ASICs, or FPGAs with custom programming to accomplish the described techniques. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

FIG. 2 is a block diagram that illustrates an example computer system with which an embodiment may be implemented. In the example of FIG. 2, a computer system 200 and instructions for implementing the disclosed technologies in hardware, software, or a combination of hardware and software, are represented schematically, for example, as boxes and circles, at the same level of detail that is commonly used by persons of ordinary skill in the art to which this disclosure pertains for communicating about computer architecture and computer systems implementations.

Computer system 200 includes an input/output (I/0) subsystem 202, which may include a bus and/or other communication mechanism(s) for communicating information and/or instructions between the components of the computer system 200 over electronic signal paths. The I/O subsystem 202 may include an I/O controller, a memory controller, and at least one I/O port. The electronic signal paths are represented schematically in the drawings, for example, as lines, unidirectional arrows, or bidirectional arrows.

At least one hardware processor 204 is coupled to I/O subsystem 202 for processing information and instructions. Hardware processor 204 may include, for example, a general purpose microprocessor or microcontroller and/or a special-purpose microprocessor such as an embedded system or a graphics processing unit (GPU), or a digital signal processor or ARM processor. Processor 204 may comprise an integrated arithmetic logic unit (ALU) or may be coupled to a separate ALU.

Computer system 200 includes one or more units of memory 206, such as a main memory, which is coupled to I/O subsystem 202 for electronically digitally storing data and instructions to be executed by processor 204. Memory 206 may include volatile memory, such as various forms of random-access memory (RAM) or other dynamic storage devices. Memory 206 also may be used for storing temporary variables or other intermediate information during the execution of instructions to be executed by processor 204. Such instructions, when stored in non-transitory computer-readable storage media accessible to processor 204, can render computer system 200 into a special-purpose machine that is customized to perform the operations specified in the instructions.

Computer system 200 further includes non-volatile memory such as read-only memory (ROM) 208 or other static storage devices coupled to I/O subsystem 202 for storing information and instructions for processor 204. The ROM 208 may include various forms of programmable ROM (PROM), such as erasable PROM (EPROM) or electrically erasable PROM (EEPROM). A unit of persistent storage 210 may include various forms of non-volatile RAM (NVRAM), such as FLASH memory, solid-state storage, magnetic disk or optical disks such as CD-ROM or DVD ROM and may be coupled to I/O subsystem 202 for storing information and instructions. Storage 210 is an example of a non-transitory computer-readable medium that may be used to store instructions and data, which, when executed by the processor 204, causes performing computer implemented methods to execute the techniques herein.

The instructions in memory 206, ROM 208, or storage 210 may comprise one or more instructions organized as modules, methods, objects, functions, routines, or calls. The instructions may be organized into one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation layer, application layer, and data storage layer such as a relational database system using a structured query language (SQL) or no SQL, an object store, a graph database, a flat file system, or other data storage.

Computer system 200 may be coupled via I/O subsystem 202 to at least one output device 212. In one embodiment, output device 212 is a digital computer display. Examples of a display that may be used in various embodiments include a touchscreen display, a light-emitting diode (LED) display, a liquid crystal display (LCD), or an e-paper display. Computer system 200 may include other types of output devices 212, alternatively or in addition to a display device. Examples of other output devices 212 include printers, ticket printers, plotters, projectors, sound cards or video cards, speakers, buzzers or piezoelectric devices or other audible devices, lamps or LED or LCD indicators, haptic devices, actuators or servos.

At least one input device 214 is coupled to I/O subsystem 202 for communicating signals, data, command selections, or gestures to processor 204. Examples of input devices 214 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 216, which may perform cursor control or other automated control functions such as navigation in a graphical interface on a display screen, alternatively or in addition to input functions. The control device 216 may be a touchpad, a mouse, a trackball, or cursor direction keys for communicating direction information and command selections to processor 204 and for controlling cursor movement on the output device 212. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism, or other types of control devices. An input device 214 may include a combination of multiple different input devices, such as a video camera and a depth sensor.

In another embodiment, computer system 200 may comprise an Internet of Things (IoT) device in which one or more of the output device 212, input device 214, and control device 216 are omitted. Or, in such an embodiment, the input device 214 may comprise one or more cameras, motion detectors, thermometers, microphones, seismic detectors, other sensors or detectors, measurement devices or encoders, and the output device 212 may comprise a special purpose display such as a single-line LED or LCD, one or more indicators, a display panel, a meter, a valve, a solenoid, an actuator or a servo.

When computer system 200 is a mobile computing device, input device 214 may comprise a global positioning system (GPS) receiver coupled to a GPS module that is capable of triangulating to a plurality of GPS satellites, determining and generating geo-location or position data such as latitude-longitude values for a geophysical location of the computer system 200. Output device 212 may include hardware, software, firmware, and interfaces for generating position reporting packets, notifications, pulse or heartbeat signals, or other recurring data transmissions that specify a position of the computer system 200, alone or in combination with other application-specific data, directed toward host computer 224 or server computer 230.

Computer system 200 may implement the techniques described herein using customized hard-wired logic, at least one ASIC or FPGA, firmware, and/or program instructions or logic which, when loaded and used or executed in combination with the computer system, causes or programs the computer system to operate as a special-purpose machine. According to one embodiment, the techniques herein are performed by computer system 200 in response to processor 204 executing at least one sequence of at least one instruction contained in main memory 206. Such instructions may be read into main memory 206 from another storage medium, such as storage 210. Execution of the sequences of instructions contained in main memory 206 causes processor 204 to perform the process steps described herein. In alternative embodiments, hard wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as storage 210. Volatile media includes dynamic memory, such as memory 206. Common forms of storage media include, for example, a hard disk, solid state drive, flash drive, magnetic data storage medium, any optical or physical data storage medium, memory chip, or the like.

Storage media is distinct but may be used with transmission media. Transmission media participates in transferring information between storage media. For example, transmission media includes coaxial cables, copper wire, fiber optics, and wires comprising a bus of I/O subsystem 202. Transmission media can also take the form of acoustic or light waves, such as those generated during radio-wave and infrared data communications.

Various forms of media may be involved in carrying at least one sequence of at least one instruction to processor 204 for execution. For example, the instructions may initially be carried on a remote computer's magnetic disk or solid-state drive. The remote computer can load the instructions into its dynamic memory and send them over a communication link such as a fiber optic, coaxial cable, or telephone line using a modem. A modem or router local to computer system 200 can receive the data on the communication link and convert the data to a format that can be read by computer system 200. For instance, a receiver such as a radio frequency antenna or an infrared detector can receive the data carried in a wireless or optical signal, and appropriate circuitry can provide the data to I/O subsystem 202, such as place the data on a bus. I/O subsystem 202 carries the data to memory 206, from which processor 204 retrieves and executes the instructions. The instructions received by memory 206 may optionally be stored on storage 210 either before or after execution by processor 204.

Computer system 200 also includes a communication interface 218 coupled to I/O subsystem 202. Communication interface 218 provides a two-way data communication coupling to network link(s) 220 that are directly or indirectly connected to at least one communication network, such as a network 222 or a public or private cloud on the Internet. For example, communication interface 218 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 222 broadly represents a local area network (LAN), wide-area network (WAN), campus network, internetwork, or any combination thereof. Communication interface 218 may comprise a LAN card to provide a data communication connection to a compatible LAN or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 218 sends and receives electrical, electromagnetic, or optical signals over signal paths that carry digital data streams representing various types of information.

Network link 220 typically provides electrical, electromagnetic, or optical data communication directly or through at least one network to other data devices, using, for example, satellite, cellular, Wi-Fi, or BLUETOOTH technology. For example, network link 220 may provide a connection through network 222 to a host computer 224.

Furthermore, network link 220 may connect through network 222 or to other computing devices via internetworking devices and/or computers operated by an Internet Service Provider (ISP) 226. ISP 226 provides data communication services through a worldwide packet data communication network, Internet 228. A server computer 230 may be coupled to Internet 228.

Server computer 230 broadly represents any computer, data center, virtual machine, or virtual computing instance with or without a hypervisor or computer executing a containerized program system such as DOCKER or KUBERNETES. Server computer 230 may represent an electronic digital service that is implemented using more than one computer or instance, and that is accessed and used by transmitting web services requests, uniform resource locator (URL) strings with parameters in HTTP payloads, API calls, app services calls, or other service calls. Computer system 200 and server computer 230 may form elements of a distributed computing system that includes other computers, a processing cluster, a server farm, or other organizations of computers that cooperate to perform tasks or execute applications or services. Server computer 230 may comprise one or more instructions organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 230 may comprise a web application server that hosts a presentation layer, application layer, and data storage layer, such as a relational database system using a structured query language (SQL) or no SQL, an object store, a graph database, a flat file system or other data storage.

Computer system 200 can send messages and receive data and instructions, including program code, through the network(s), network link 220, and communication interface 218. In the Internet example, server computer 230 might transmit a requested code for an application program through Internet 228, ISP 226, local network 222, and communication interface 218. The received code may be executed by processor 204 as it is received and/or stored in storage 210 or other nonvolatile storage for later execution.

The execution of instructions, as described in this section, may implement a process in the form of an instance of a computer program that is being executed, consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 204. While each processor 204 or core of the processor executes a single task at a time, computer system 200 may be programmed to implement multitasking to allow each processor to switch between tasks that are being executed without having to wait for each task to finish. In an embodiment, switches may be performed when tasks perform input/output operations when a task indicates that it can be switched or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

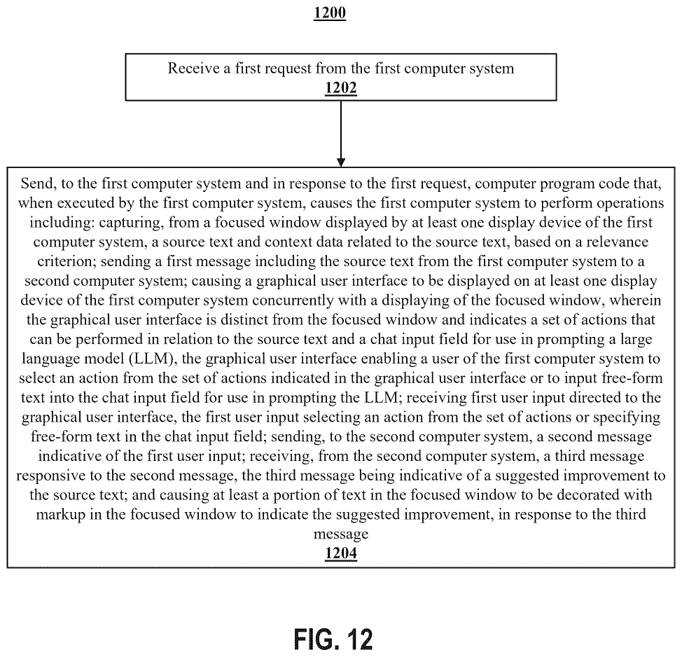

FIG. 12 is a flowchart of an example process 1200 according to the technique introduced above. In some implementations, the process 1200 may be performed by one or more computer systems. As shown in FIG. 12, at step 1202, process 1200 includes receiving a first request from the first computer system (block 1202). At step 1204, process 1200 includes sending, to the first computer system and in response to the first request, computer program code that, when executed by the first computer system, causes the first computer system to perform operations including: capturing, from a focused window displayed by at least one display device of the first computer system, a source text and context data related to the source text, based on a relevance criterion; sending a first message including the source text from the first computer system to a second computer system; causing a graphical user interface to be displayed on at least one display device of the first computer system concurrently with a displaying of the focused window, where the graphical user interface is distinct from the focused window and indicates a set of actions that can be performed in relation to the source text and a chat input field for use in prompting a large language model (LLM), the graphical user interface enabling an user of the first computer system to select an action from the set of actions indicated in the graphical user interface or to input free-form text into the chat input field for use in prompting the LLM; receiving first user input directed to the graphical user interface, the first user input selecting an action from the set of actions or specifying free-form text in the chat input field; sending, to the second computer system, a second message indicative of the first user input; receiving, from the second computer system, a third message responsive to the second message, the third message being indicative of a suggested improvement to the source text; and causing at least a portion of text in the focused window to be decorated with markup in the focused window to indicate the suggested improvement, in response to the third message (block 1204). Although FIG. 12 shows example blocks of process 1200, in some implementations, process 1200 may include additional blocks, fewer blocks, different blocks, or differently arranged blocks than those depicted in FIG. 12. Additionally, or alternatively, two or more of the blocks of process 1200 may be performed in parallel.

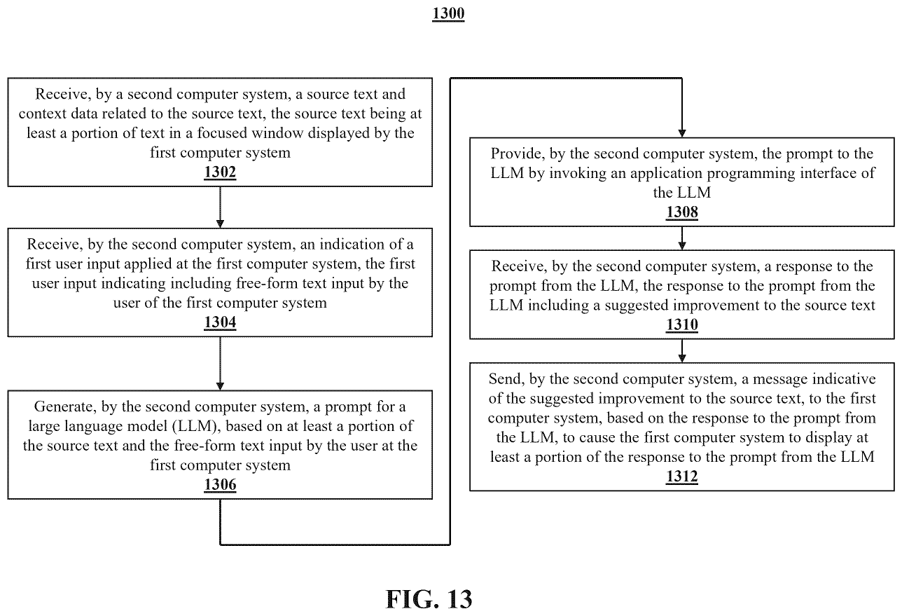

FIG. 13 is a flowchart of another example process 1300 according to the technique introduced above. In some implementations, the process 1300 may be performed by one or more computer systems. As shown in FIG. 13, process 1300 includes, at step 1302 receiving, by a second computer system, a source text and context data related to the source text, the source text being at least a portion of text in a focused window displayed by the first computer system. At step 1304, process 1300 includes receiving, by the second computer system, an indication of a first user input applied at the first computer system, the first user input indicating including free-form text input by the user of the first computer system. At step 1306, process 1300 includes generating, by the second computer system, a prompt for a large language model (LLM), based on at least a portion of the source text and the free-form text input by the user at the first computer system. At step 1308, process 1300 includes providing, by the second computer system, the prompt to the LLM by invoking an application programming interface of the LLM. At step 1310, process 1300 includes receiving, by the second computer system, a response to the prompt from the LLM, the response to the prompt from the LLM including a suggested improvement to the source text. At step 1312, process 1300 includes sending, by the second computer system, a message indicative of the suggested improvement to the source text, to the first computer system, based on the response to the prompt from the LLM, to cause the first computer system to display at least a portion of the response to the prompt from the LLM.

Although FIG. 13 shows example blocks of process 1300, in some implementations, process 1300 may include additional blocks, fewer blocks, different blocks, or differently arranged blocks than those depicted in FIG. 13. Additionally, or alternatively, two or more of the blocks of process 1300 may be performed in parallel.

In the foregoing specification, embodiments of the invention have been described regarding numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method of enabling provision of writing assistance to a user of a first computer system, the method comprising:
receiving a first request from the first computer system; and
sending, to the first computer system and in response to the first request, computer program code that, when executed by the first computer system, causes the first computer system to perform operations including:
capturing, from a focused window displayed by at least one display device of the first computer system, a source text and context data related to the source text, based on a relevance criterion;
sending a first message including the source text from the first computer system to a second computer system;
causing a graphical user interface to be displayed on at least one display device of the first computer system concurrently with a displaying of the focused window, wherein the graphical user interface is distinct from the focused window and indicates a set of actions that can be performed in relation to the source text and a chat input field for use in prompting a large language model (LLM), the graphical user interface enabling a user of the first computer system to select an action from the set of actions indicated in the graphical user interface or to input free-form text into the chat input field for use in prompting the LLM;
receiving first user input directed to the graphical user interface, the first user input selecting an action from the set of actions or specifying free-form text in the chat input field;
sending, to the second computer system, a second message indicative of the first user input;
receiving, from the second computer system, a third message responsive to the second message, the third message being indicative of a suggested improvement to the source text; and
causing at least a portion of text in the focused window to be decorated with markup in the focused window to indicate the suggested improvement, in response to the third message.

2. The method of claim 1, wherein in response to the first user input comprising free-form text input into the chat input field, the third message includes at least a portion of a response by the LLM to a prompt that was based on the first user input.

3. The method of claim 1, further comprising:
applying, by the first computer system, a transformation to the suggested improvement based on a writing quality criterion, to produce a transformed suggested improvement;
wherein the causing at least a portion of text in the focused window to be decorated in the focused window is based on the transformed suggested improvement.

4. The method of claim 1, wherein the source text comprises text located in an active field of the focused window and the context data comprises text outside the active field of the focused window.

5. The method of claim 1, wherein the source text comprises selected text in the focused window and the context data comprises unselected text in the focused window.

6. The method of claim 1, wherein the capturing filters out control elements from the focused window.

7. The method of claim 1, wherein the capturing comprises traversing a hierarchical metadata structure representative of the focused window to extract relevant content.

8. The method of claim 7, wherein the hierarchical metadata structure is an accessibility tree.

9. The method of claim 7, wherein the hierarchical metadata structure is a document object model (DOM).

10. The method of claim 7, wherein the capturing comprises:
accessing the hierarchical metadata structure;
selecting first data elements of the hierarchical metadata structure corresponding to specified attributes; and
pruning second data elements from the hierarchical metadata structure based on a specified relevance criterion.

11. The method of claim 7, wherein the hierarchical metadata structure is in a JSON format, and wherein the capturing further comprises converting at least a portion of the hierarchical metadata structure from the JSON format to whitespace-indented text.

12. The method of claim 1, wherein the source text comprises an entire email thread, and wherein one of the actions, of the set of actions, is to summarize the entire email thread.

13. A method of providing writing assistance to a user of a first computer system, the method comprising:
receiving, by a second computer system, a source text and context data related to the source text, the source text being at least a portion of text in a focused window displayed by the first computer system;
receiving, by the second computer system, an indication of a first user input applied at the first computer system, the first user input indicating including free-form text input by the user of the first computer system;
generating, by the second computer system, a prompt for a large language model (LLM), based on at least a portion of the source text and the free-form text input by the user at the first computer system;
providing, by the second computer system, the prompt to the LLM by invoking an application programming interface of the LLM;
receiving, by the second computer system, a response to the prompt from the LLM, the response to the prompt from the LLM including a suggested improvement to the source text; and
sending, by the second computer system, a message indicative of the suggested improvement to the first computer system, based on the response to the prompt from the LLM, to cause the first computer system to display at least a portion of the response to the prompt from the LLM.

14. The method of claim 13, further comprising:
applying, by the second computer system, a transformation to the suggested improvement to the source text based on a writing quality criterion, to produce a transformed suggested improvement, wherein the message indicative of the suggested improvement contains the transformed suggested improvement.

15. The method of claim 13, further comprising:
receiving or generating, by the second computer system, a subset of a hierarchical metadata structure representative of content of the focused window, wherein the generating the prompt is based on the subset of the hierarchical metadata structure and the free-form text input by the user at the first computer system.

16. The method of claim 15, wherein the hierarchical metadata structure is an accessibility tree.

17. The method of claim 15, wherein the hierarchical metadata structure is a document object model (DOM).

18. The method of claim 15, wherein the hierarchical metadata structure is in a JSON format, and wherein the subset of the hierarchical metadata structure is in a whitespace-indented text format.

19. The method of claim 15, wherein generating the prompt comprises generating a plurality of user messages, including generating a separate user message to include each of:
a user-selected portion of text from the focused window, if any text in the focused window has been selected by the user of the first computer system;
a processed hierarchical metadata structure representative of the focused window; and
a user-input request or question input by the user of the first computer system.

20. The method of claim 13, wherein the source text and the context data collectively comprise an entire email thread.

21. A system for providing context-aware text suggestions in conjunction with text entered in an application window, the system comprising:
at least one processor; and
at least one memory, accessible to the processor and storing program code comprising:
a text processing extension configured to execute on a client computing device and configured to monitor a focused application window to capture a body of text and context data;
a prompt engineering module configured to execute on a server and configured to:
upon receipt of the body of text and context data, select one or more writing actions from a predefined set of candidate actions based on the captured context data;
generate one or more engineered prompts for a large language model by applying prompt logic to the writing actions, the context data, and a user-specified or default writing style;
a language model interface module configured to transmit the one or more engineered prompts to a large language model and to receive one or more generated text responses;
a response unifier module configured to unify the one or more generated text responses into a unified suggestion set; and
a presentation module configured to execute on the client computing device and configured to:
receive the unified suggestion set; and
present at least one suggested text to a user either as inline decorations in the focused application window, wherein additions are highlighted and deletions are struck through relative to the captured body of text.
